(19) United States
(12) Patent Application Publication
(10) Pub. No.: US 2019/0072731 A1
(43) Pub. Date: Mar. 7, 2019

(54) LIGHT SOURCE DEVICE

(71) Applicant: NEC Corporation, Tokyo (JP)

(72) Inventor: Hiroyuki YAMAZAKI, Tokyo (JP)

(73) Assignee: NEC Corporation, Tokyo (JP)

(21) Appl. No.: 16/084,351

(22) PCT Filed: Mar. 15, 2017
(86) PCT No.: PCT/JP2017/010413

§ 371 Date: Sep. 12, 2018

(30) Foreign Application Priority Data
Mar. 24, 2016 (JP) 2016-059869

(51) Int. Cl. G02B 6/42; G02B 6/02; H04B 10/572

(52) U.S. Cl. CPC G02B 6/4208; H04B 10/572; G02B 6/02076; G02B 6/4216

(57) ABSTRACT

In this light source device, in order to reduce the size thereof and reduce the line width, a first optical fiber 12 is optically coupled to a light source 11. Through the first optical fiber 12, light that has exited from the light source 11 is let into a second optical fiber 14 to be guided thereby. An optical isolator 13 is inserted between the first optical fiber 12 and the second optical fiber 14. An optical fiber that readily generates back-scattering is used for the first optical fiber 12. As light that has back-scattered in the first optical fiber 12 returns to the light source 11, and by constituting a long resonator, the line width of the output light can be reduced.

### TECHNICAL FIELD

The present invention relates to a light source device and, more particularly, to a light source device in which light that has exited from a light source is guided by using an optical fiber. The invention also relates to an optical signal transmitter, an optical signal receiver, an optical signal transceiver, and an optical transmission system each including such a light source device.

### BACKGROUND ART

Digital coherent communication is under earnest study in order to expand the communication capacity.

In the digital coherent communication system, there is a demand for a light source that operates in a narrow line width configuration, which has small variations in wavelength or phase. For example, the Dual Polarization-Quadrature Phase Shift Keying (DP-QPSK) currently in practical use requires a line width of 500 kHz or less. The 16 Quadrature Amplitude Modulation (16QAM) as a next-generation technique requires a line width of 100 kHz or less. Further, the 64QAM advanced in terms of multi-value modulation requires a line width of 1.5 kHz or less.

Increasing a resonator length is necessary for providing a laser operating in a narrow line width configuration. Narrow line width lasers with an increased resonator length have been commercialized as external resonator configurations. However, the offered line widths are in the neighborhood of 100 kHz, which line widths are insufficient for use of the 64QAM.

PTL 1 describes a semiconductor light source providing a narrow line width. The semiconductor light source described in PTL 1 includes a tunable distributed reflector semiconductor laser and a first optical fiber, having a predetermined length, disposed with one end thereof connected to the emitting surface of the semiconductor laser. The first optical fiber is optically connected to a second optical fiber via an optical isolator. A single-mode optical fiber is used for each of the first and second optical fibers.

Generally speaking, optical fibers exhibit a micro non-uniformity in the diameter and refractive index of a core as a waveguide. In optical fibers, there is a non-uniform distribution of refractive index along the direction of propagation of light. The distribution of non-uniform refractive index generates micro-reflection sources of the distributed constant type and a part of light incident on an optical fiber returns, as back-scattered light, to a light source. PTL 1 describes that the intensity of the back-scattered light is about −40 dB when the optical fiber length of the first optical fiber is assumed to be 1 km. When an optical fiber having such an optical length is used for the first optical fiber, the first optical fiber as a waveguide also operates as a reflecting mirror in a self-aligned manner. With the semiconductor light source described in PTL 1, the length of an external resonator is effectively increased by feeding back a part of the light incident on the first optical fiber to the distributed reflector semiconductor laser, which configuration reduces the line width. In relation to the invention, PTL 2 describes a semiconductor laser module for narrowing the oscillation wavelength band.

### CITATION LIST

### Patent Literature

### PTL 1: Japanese Unexamined Patent Application Publication No. 1992-320081

### PTL 2: Japanese Unexamined Patent Application Publication No. 2000-077773

### SUMMARY OF INVENTION

### Technical Problem

Although increasing a resonator length is effective for achieving a narrow line width characteristic, there is a concern about unstable oscillations caused by a reduced mode interval. In order to avoid this problem, a wavelength filter is in need having a relatively steep wavelength selectivity, which complicates the filter configuration.

Another plan is reported: achieving a narrow line width characteristic through negative feedback control of a driving current of a light source or phase in a cavity in such a way as to detect a frequency noise component and cancel the frequency noise component. The plan, however, leads to a complicated control system, which approach is not practical.

As still another plan, there is proposed a method for reducing the line width by performing, through an optical filter, conversion of frequency to light intensity of laser oscillation light that has exited from a light source for the purpose of optimal phase control. This method offers a simpler structure than the aforementioned negative feedback control. A problem with this approach is that it is necessary to provide an optical filter and control the same.

According to PTL 1, the line width is reduced by feeding back the back-scattered light generated in the first optical fiber to the distributed reflector semiconductor laser. According to PTL 1, none of the complicated structures or control methods mentioned above are required to obtain a narrow line width. However, according to PTL 1, the first optical fiber requires an optical fiber length of about 1 km in order to feedback laser light of sufficient intensity to the distributed reflector semiconductor laser. Thus, there is a problem that it is difficult to reduce the size of the semiconductor light source described in PTL 1.

In consideration of the aforementioned problems, the invention aims to provide a light source device capable of reducing the line width while reducing the device size, as well as an optical signal transmitter, an optical signal receiver, an optical signal transceiver, and an optical transmission system each including such a light source device.

### Solution to Problem

In order to achieve the aforementioned object, the invention provides a light source device including: a light source; a first optical fiber optically connected to the light source; a second optical fiber for inputting light that has exited from the light source through the first optical fiber and guiding the light incident; and an optical isolator inserted between the first optical fiber and the second optical fiber; the first optical fiber readily generating back-scattering as compared with the second optical fiber.

The invention also provides an optical signal transmitter including the light source device according to the invention.

The invention provides an optical signal receiver including the light source device according to above-described invention.

The invention provides an optical signal transceiver including the light source device according to above-described invention.

Further, the invention provides an optical transmission system including at least one of the optical signal transmitter, the optical signal receiver and the optical signal transceiver according to above-described invention.

A light generating method according to the invention is characterized by: causing light that has exited from a light source to pass through a first optical fiber that readily generates back-scattering as compared with a second optical fiber; disposing an optical isolator between the first optical fiber and the second optical fiber; causing the light transmitted through the first optical fiber to pass through the optical isolator; and inputting the light transmitted through the optical isolator to the second optical fiber.

### Advantageous Effects of Invention

The light source device, the optical signal transmitter, and the optical transmission system according to the invention are capable of reducing the line width while reducing the size of the light source device.

### BRIEF DESCRIPTION OF DRAWINGS

FIG. 1 is a block diagram illustrating an example embodiment of a light source device according to the invention.

FIG. 2 is a block diagram illustrating a light source device according to an example embodiment of the invention.

FIG. 3 is a block diagram illustrating an optical transmission system including an optical signal transmitter and an optical signal receiver each including the light source device according to an example embodiment.

FIG. 4 is a block diagram illustrating an optical signal transceiver including an optical signal transmitter and an optical signal receiver.

### EXAMPLE EMBODIMENT

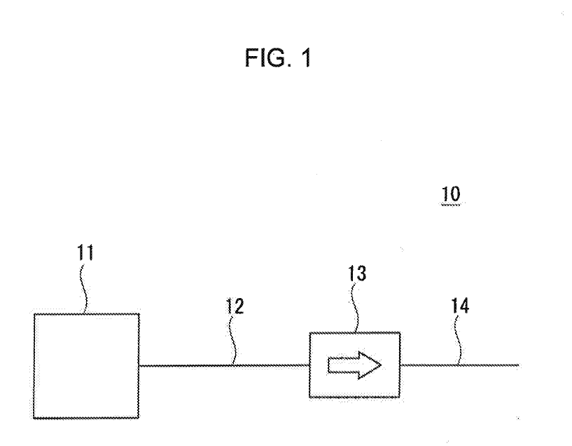

The invention will be summarized prior to description of an example embodiment of the invention. FIG. 1 illustrates an example embodiment of a light source device according to the invention. A light source device 10 includes a light source 11, a first optical fiber 12, an optical isolator 13, and a second optical fiber 14. The light source 11 emits light. The light source 11 is, for example, a laser light source that emits laser light. The first optical fiber 12 is an optical fiber for guiding the light that has exited from the light source 11. The first optical fiber 12 is optically connected to the light source 11.

The second optical fiber 14 is an optical fiber for inputting light that has exited from the light source 11 through the first optical fiber 12 and guiding the incident light. The optical isolator 13 is inserted between the first optical fiber 12 and the second optical fiber 14. The optical isolator 13 gives a larger insertion loss to the light traveling in the direction from the second optical fiber 14 to the first optical fiber 12 than the light traveling in the direction from the first optical fiber 12 to the second optical fiber 14.

A part of the light incident on the first optical fiber 12 returns to the light source 11 due to various types of scattering in the first optical fiber 12. A resonator length is increased by feeding back the light to the light source 11, which configuration achieves small phase fluctuations of the laser oscillation, thereby reducing the line width of output laser light.

In the light source device 10 illustrated in FIG. 1, an optical fiber that readily generates back-scattering as compared with the second optical fiber 14 is used for the first optical fiber 12. When an optical fiber that readily generates back-scattering is used for the first optical fiber 12, it is possible to feedback light of sufficient intensity from the first optical fiber 12 to the light source 11 without extremely increasing the fiber length of the first optical fiber 12. Thus, with the light source device 10, it is possible to reduce the line width of the emitted light while reducing the device size.

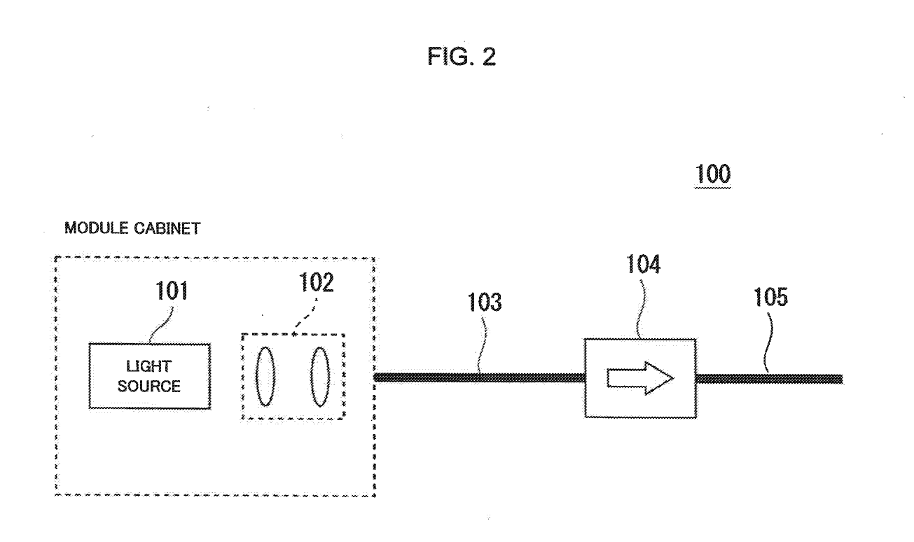

An example embodiment of the invention will be described in detail with reference to the attached drawings. FIG. 2 illustrates a light source device according to an example embodiment of the invention. A light source device 100 includes a light source 101, a coupling optical system 102, a first optical fiber 103, an optical isolator 104, and a second optical fiber 105. The light source 101 is composed, for example, as a semiconductor laser light source. The light source 101 may be a semiconductor laser light source that emits light of a single wavelength or a tunable semiconductor laser light source that emits light of a plurality of wavelengths.

The light that has exited from the light source 101 is incident on the first optical fiber 103 via the coupling optical system 102. The coupling optical system 102 includes, for example, a plurality of lenses. More particularly, the coupling optical system 102 includes, for example, a collimator lens and a condensing lens. The light that has exited from the light source 101 is collimated by using the collimator lens and condensed on the light incidence end of the first optical fiber 103 by using the condensing lens. The light source 101 and the coupling optical system 102 are disposed, for example, in the cabinet or module cabinet of the device's main body.

The second optical fiber 105 is an optical fiber for inputting light that has exited from the light source 101 through the first optical fiber 103 and guiding the incident light. For example, a single-mode fiber is used for the second optical fiber 105. The second optical fiber 105 may be a polarization maintaining fiber.

The optical isolator 104 is inserted between the first optical fiber 103 and the second optical fiber 105. The optical isolator 104 is an element having an insertion loss that is different between a direction from the first optical fiber 103 to the second optical fiber 105 (a first direction) and a direction from the second optical fiber 105 to the first optical fiber 103 (a second direction). The insertion loss of the optical isolator 104 in the first direction is smaller than that in the second direction.

In the example embodiment, an optical fiber that readily generates back-scattering as compared with the second optical fiber 105 is used for the first optical fiber 103. The first optical fiber 103 is, for example, a polarization maintaining fiber. Alternatively, the first optical fiber 103 may be a distribution-shifted fiber. Note that the first optical fiber 103 may be any optical fiber that readily generates back-scattering as compared with the second optical fiber 105, and the type of an optical fiber need not be different between the first optical fiber 103 and the second optical fiber 105. In other words, the same type of optical fiber may be used for each of the first optical fiber 103 and the second optical fiber 105. For example, a polarization maintaining fiber may be used for both the first optical fiber 103 and the second optical fiber 105. In that case, a polarization maintaining fiber that readily generates back-scattering as compared with a polarization maintaining fiber constituting the second optical fiber 105 is used for the first optical fiber 103.

The first optical fiber 103 may be an optical fiber including a Fiber Bragg Grating (FBG). The word FBG herein refers to a fiber-type device where a periodic change in refractive index occurs in the refractive index of an optical fiber core. In an FBG, a change in refractive index functions as a grating or a diffraction grating. The first optical fiber 103 includes an FBG (a diffraction grating) or a diffraction grating, for example, in the vicinity of the near side of the optical isolator 104, that is, at the far side from the light source 101.

Generally speaking, an FBG reflects a particular wavelength component alone called the Bragg wavelength of incident light that is determined based on the cycle of a diffraction grating, and transmits the other wavelength components. The Bragg wavelength λ_{B} is represented by λ_{B}=2nΛ assuming that n is an effective refractive index in the optical fiber core and Λ is the cycle of the diffraction grating. The Bragg wavelength of the FBG included in the first optical fiber 103 differs from the wavelength of the light that has exited from the light source 101. The FBG reflects a part of light incident from the light source 101 on the first optical fiber 103 toward the light source 101.

The cycle of the diffraction grating of the FBG included in the first optical fiber 103 is set to, for example, the cycle obtained by multiplying the cycle of the diffraction grating Λ calculated by substituting the wavelength of the light that has exited from the light source 101 for the Bragg wavelength λ_{B} in the aforementioned equation by a predetermined coefficient. In other words, the cycle of the diffraction grating of the FBG included in the first optical fiber 103 is set to, for example, the cycle obtained by multiplying the cycle of the diffraction grating assumed when the Bragg wavelength is equal to the wavelength of the light that has exited from the light source 101 by a predetermined coefficient. The predetermined coefficient may be, for example, a value of 1.5 or 1.2. In that case, the first optical fiber 103 includes an FBG in which is formed a diffraction grating having a cycle 1.5 times longer than the cycle Λ obtained via the aforementioned calculation or a diffraction grating having a cycle 1.2 times longer than the cycle Λ obtained via the aforementioned calculation.

The cycle of the diffraction grating of the FBG in the first optical fiber 103 may have a predetermined variation width rather than being constant. To put it another way, the coefficient used for multiplication of the cycle Λ obtained via the aforementioned calculation need not be a constant fixed value over the entire length of the FBG. For example, a cycle that is 1.5 times longer than the cycle Λ obtained via the aforementioned calculation and a cycle that is 1.2 times longer than the same may coexist in the FBG. When a plurality of cycles of a diffraction grating coexist in the FBG, for example when the light source 101 is a tunable laser light source or the like, it is possible to feedback light having a wide range of frequencies to the light source 101.

Instead of the aforementioned configurations, the first optical fiber 103 may be an optical fiber having a smaller core diameter than ordinary optical fibers. For example, the core diameter of the first optical fiber 103 is smaller than that of the second optical fiber 105. An optical fiber having a reduced core diameter tends to become structurally non-uniform. Using an optical fiber having a relatively small core diameter for the first optical fiber 103 increases back-scattering in the first optical fiber 103, due to nonlinear effect, as compared with a case where an optical fiber having an ordinary core diameter is used.

When intense light is incident on the first optical fiber 103 in the light source device 100 according to the example embodiment, the light is back-scattered due to various types of scattering in the first optical fiber 103, thus generating light that returns to the light source 101 from the first optical fiber 103. A resonator length is increased by feeding back the light to the light source 101, which configuration achieves small phase fluctuations of the laser oscillation, thereby reducing the line width of the output laser light.

The light source device 100 according to the example embodiment includes the optical isolator 104 between the first optical fiber 103 that readily generates back-scattering and the second optical fiber 105. Light traveling through the optical isolator 104 in the direction from the first optical fiber 103 to the second optical fiber 105 suffers a small loss. The optical isolator 104 transmits, with a small loss, the light traveling in the direction from the first optical fiber 103 to the second optical fiber 105. Note that, at the connection part of the first optical fiber 103 and the optical isolator 104, it is assumed that almost no optical reflections occur, or an optical reflection, if any, is sufficiently weaker than the light that is back-scattered in the first optical fiber 103 and returns to the light source 101.

On the other hand, light traveling through the optical isolator 104 in the direction from the second optical fiber 105 to the first optical fiber 103 suffers a large loss. The optical isolator 104 attenuates the light traveling in the direction from the second optical fiber 105 to the first optical fiber 103. By using the optical isolator 104 configured in this way, it is possible to limit light that returns to the light source 101 to the return light generated at a point before the far end of the first optical fiber 103 as viewed from the light source 101.

In the example embodiment, an optical fiber that readily generates back-scattering is used for the first optical fiber 103 optically connected to the light source 101. A resonator length is increased by feeding back the light back-scattered in the first optical fiber 103 to the light source 101, which configuration dramatically reduces the line width of the output light. For example, the light source device 100 according to the example embodiment is capable of reducing, by about an order of magnitude, the line width of the light output from the light source 101. The light source device 100 according to the example embodiment may be suitably used for digital coherent communication where there is a demand for a light source operating in a narrow line width configuration.

In the example embodiment, in particular, an optical fiber that readily generates back-scattering is used for the first optical fiber 103, and it is thus possible to further reduce the optical fiber length of the first optical fiber 103 as compared with the semiconductor light source described in PTL 1. For example, while an optical fiber length of about 1 km is required in PTL 1, it is possible to reduce the fiber length of the first optical fiber 103 to several tens of centimeters in the light source device 100 according to the example embodiment. An optical fiber with a short optical fiber length may be used for the first optical fiber 103 in the example embodiment, thereby allowing further reduction of device size as compared with PTL 1.

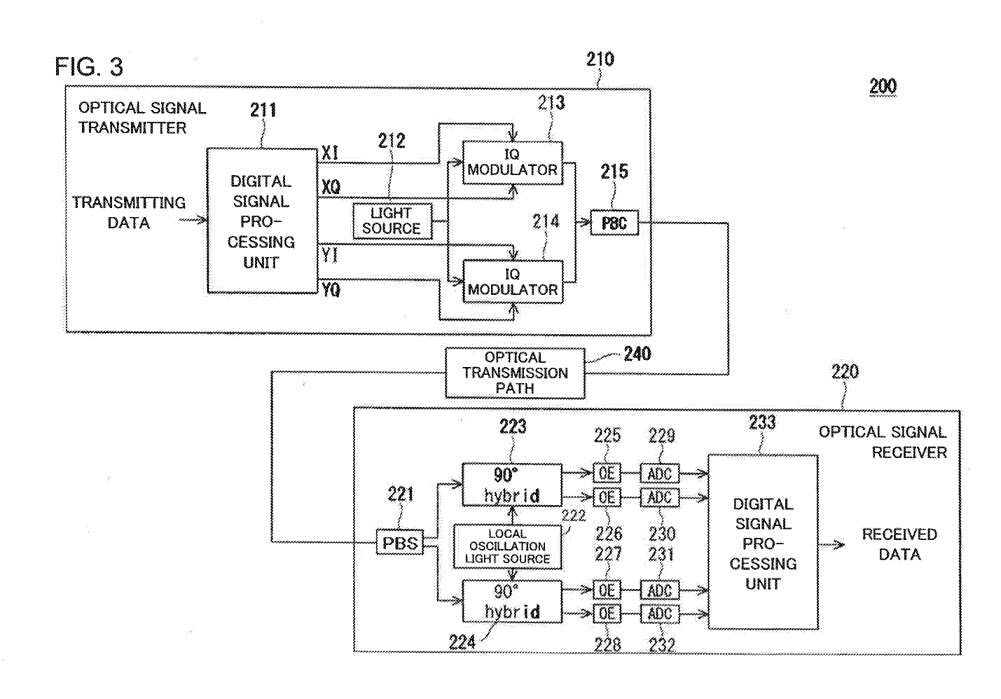

Next, an example where the light source device 100 is applied to an optical signal transmitter and an optical signal receiver will be described. FIG. 3 illustrates an optical transmission system including an optical signal transmitter and an optical signal receiver. An optical transmission system 200 is composed, for example, as an optical communication system that employs a digital coherent transmission technique. The optical transmission system 200 includes an optical signal transmitter 210 and an optical signal receiver 220.

The optical signal transmitter 210 and the optical signal receiver 220 are connected to each other via an optical transmission path 240 consisting of an optical fiber or the like. The optical transmission system 200 uses, for example, the Dual Polarization-Quadrature Phase Shift Keying (DP-QPSK) as a modulation scheme of optical signals.

The optical signal transmitter 210 typically includes a digital signal processing unit 211, a light source 212, IQ modulators 213, 214, and a polarization beam combiner (or polarization combining coupler) 215. The digital signal processing unit 211 performs digital signal processing on transmitting data signals. The digital signal processing unit 211 consists, for example, of a digital signal processor (DSP) or a large scale integration (LSI) or the like. For example, the digital signal processing unit 211 generates data XI and YI and data XQ and YQ to be superimposed, respectively as an in-phase (I) component and a quadrature (Q) component, on two polarizations X and Y that are orthogonal to each other. The data XI and XQ respectively represent I component data and Q component data to be superimposed on the polarization X and the data YI and YQ respectively represent I component data and Q component data to be superimposed on the polarization Y.

The light source 212 emits light for transmission. For example, the light source 212 includes a configuration where the output of the light source device 100 illustrated in FIG. 2 is branched. The light exited from the light source 212 is input to the IQ modulators 213, 214. The IQ modulators 213, 214 are each composed as a multi-value phase modulator. The IQ modulator 213 is a modulator corresponding to X polarization and the IQ modulator 214 is a modulator corresponding to Y polarization. The IQ modulators 213, 214 are each composed, for example, as a Mach-Zehnder optical modulator. The IQ modulator 213 generates X polarization modulated signal light by modulating light input from the light source 212 by using a driving signal corresponding to the data XI or XQ. The IQ modulator 214 generates Y polarization modulated signal light by modulating light input from the light source 212 by using a driving signal corresponding to the data YI or YQ.

The polarization beam combiner 215 polarization-combines the X polarization modulated signal light generated by the IQ modulator 213 and the Y polarization modulated signal light generated by the IQ modulator 214. The optical signal transmitter 210 transmits toward the optical transmission path 240 the modulated signal light, also called the polarization multiplexed signal light, which has been polarization-combined. The optical signal receiver 220 receives the polarization multiplexed signal light through the optical transmission path 240.

The optical signal receiver 220 typically includes a polarization beam splitter 221, a local oscillation light source 222, a 90-degree optical hybrids 223, 224, optical-to-electrical converters 225-228, analog to digital (A-D) converters 229-232, and a digital signal processing unit 233. The polarization beam splitter 221 splits the polarization multiplexed signal light received through the optical transmission path 240 into two polarization components that are orthogonal to each other. In other words, the polarization beam splitter 221 splits the polarization multiplexed signal light into an X polarization component and a Y polarization component. The X polarization component light or X polarization modulated signal light obtained through splitting by the polarization beam splitter 221 is input to the 90-degree optical hybrid 223 and the Y polarization component light or Y polarization modulated signal light is input to the 90-degree optical hybrid 224.

The local oscillation light source 222 is a light source that outputs local oscillation light used for detection of light in the 90-degree optical hybrids 223, 224. The local oscillation light source 222 uses, for example, a configuration where the output of the light source device 100 illustrated in FIG. 2 is branched. The 90-degree optical hybrid 223 is a demodulator corresponding to the X polarization component and the 90-degree optical hybrid 224 is a demodulator corresponding to Y polarization. The 90-degree optical hybrid 223 detects the X polarization modulated signal light input from the polarization beam splitter 221 by using the local oscillation light input from the local oscillation light source 222 and outputs detection light of I component and Q component.

The 90-degree optical hybrid 224 detects the Y polarization modulated signal light input from the polarization beam splitter 221 by using the local oscillation light input from the local oscillation light source 222 and outputs detection light of I component and Q component.

The optical-to-electrical converters 225-228 convert light to an electrical signal. The optical-to-electrical converters 225, 226 are converters corresponding to the X polarization component and the optical-to-electrical converters 227, 228 are converters corresponding to the Y polarization component. The optical-to-electrical converter 225 converts, to an electrical signal, the detection light of I component output by the 90-degree optical hybrid 223 corresponding to the X polarization component and the optical-to-electrical converter 226 converts, to an electrical signal, the detection light of Q component output by the 90-degree optical hybrid 223. The optical-to-electrical converter 227 converts, to an electrical signal, the detection light of I component output by the 90-degree optical hybrid 224 corresponding to the Y polarization component and the optical-to-electrical converter 228 converts, to an electrical signal, the detection light of Q component output by the 90-degree optical hybrid 224.

The A-D converters 229-232 converts an analog electrical signal to a digital signal. The A-D converters 229, 230 are A-D converters corresponding to the X polarization component and the A-D converters 231, 232 are A-D converters corresponding to the Y polarization component. The A-D converter 229 converts, to a digital signal, the electrical signal obtained through conversion by the optical-to-electrical converter 225 and corresponding to the detection light of X polarization I component. The A-D converter 230 converts, to a digital signal, the electrical signal obtained through conversion by the optical-to-electrical converter 226 and corresponding to the detection light of X polarization Q component. The A-D converter 231 converts, to a digital signal, the electrical signal obtained through conversion by the optical-to-electrical converter 227 and corresponding to the detection light of Y polarization I component. The A-D converter 232 converts, to a digital signal, the electrical signal obtained through conversion by the optical-to-electrical converter 228 and corresponding to the detection light of Y polarization Q component.

The digital signal processing unit 233 performs digital signal processing on a digital signal input from the A-D converters 229-232. The digital signal processing unit 233 reproduces received data from the transmitting data modulated in the optical signal transmitter 210, for example, based on the input digital signal. The digital signal processing unit 233 consists of, for example, a DSP or an LSI or the like.

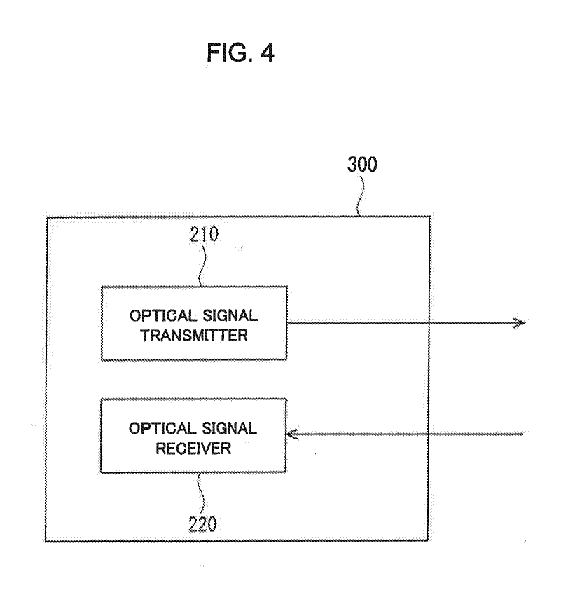

In the example illustrated above, the optical signal transmitter 210 and the optical signal receiver 220 face each other across the optical transmission path 240. However, the optical signal transmitter 210 and the optical signal receiver 220 need not be necessarily separate from each other, but the optical signal transmitter 210 and the optical signal receiver 220 may be included in a single device. FIG. 4 illustrates an optical signal transceiver including the optical signal transmitter 210 and the optical signal receiver 220. Configuration of the optical signal transmitter 210 and the optical signal receiver 220 may be similar to that illustrated in FIG. 3. The optical transmission system may include the optical signal transceiver 300 illustrated in FIG. 4 at either end of the optical transmission path 240. In that case, the optical transmission system performs bidirectional transmission and reception of optical signals through the optical transmission path 240.

While the light source device 100 according to the aforementioned example embodiment is applied to an optical transmission system in the foregoing example, the light source device 100 is not limited thereto. The light source device 100 according to the aforementioned example may be applied to other applications where there is a demand for operation in a narrow line width configuration. For example, the light source device 100 may be used for optical measurement applications where measurement is made by using light that has exited from the light source 101.

A part or a whole of the abovementioned example embodiment may be described under, but not limited to, the following supplementary notes.

### (Supplementary Note 1)

A light source device including:

a light source;

a first optical fiber optically connected to the light source;

a second optical fiber for inputting light that has exited from the light source through the first optical fiber and guiding the light incident; and

an optical isolator inserted between the first optical fiber and the second optical fiber,

wherein

the first optical fiber readily generates back-scattering compared with the second optical fiber.

### (Supplementary Note 2)

The light source device according to supplementary note 1, wherein the first optical fiber is a polarization maintaining fiber.

### (Supplementary Note 3)

The light source device according to supplementary note 1, wherein

the first optical fiber includes a Fiber Bragg Grating, and

Bragg wavelength of the Fiber Bragg Grating differs from the wavelength of the light that has exited from the light source.

### (Supplementary Note 4)

The light source device according to supplementary note 3, wherein

the cycle of the diffraction grating of the Fiber Bragg Grating is a cycle obtained by multiplying the cycle of the diffraction grating assumed when the Bragg wavelength is equal to the wavelength of the light that has exited from the light source by a predetermined coefficient.

### (Supplementary Note 5)

The light source device according to supplementary note 1, wherein the first optical fiber is a distribution-shifted fiber.

### (Supplementary Note 6)

The light source device according to supplementary note 1, wherein a core diameter of the first optical fiber is smaller than a core diameter of the second optical fiber.

### (Supplementary Note 7)

The light source device according to any one of supplementary notes 1 to 6, further including a coupling optical system between the light source and the first optical fiber.

### (Supplementary Note 8)

An optical signal transmitter including the light source device according to any one of supplementary notes 1 to 7.

### (Supplementary Note 9)

An optical signal receiver including the light source device according to any one of supplementary notes 1 to 7.

### (Supplementary Note 10)

An optical signal transceiver including the light source device according to any one of supplementary notes 1 to 7.

### (Supplementary Note 11)

An optical transmission system including at least one of the optical signal transmitter according to supplementary note 8, the optical signal receiver according to supplementary note 9 and the optical signal transceiver according to supplementary note 10.

### (Supplementary Note 12)

A light generating method for:

causing light that has exited from a light source to pass through a first optical fiber that readily generates back-scattering as compared with a second optical fiber;

disposing an optical isolator between the first optical fiber and the second optical fiber;

causing the light transmitted through the first optical fiber to pass through the optical isolator; and

inputting the light transmitted through the optical isolator to the second optical fiber.

While an example embodiment of the invention has been described in detail, the invention is not limited to the aforementioned example embodiment. Modifications or variations of the example embodiment within the spirit of the invention are included in the invention.

The present application claims priority based on Japanese Patent Application No. 2016-059869, filed on Mar. 24, 2016, the entire disclosure of which is incorporated herein.

### REFERENCE SIGNS LIST

10: Light source device
11: Light source
12: First optical fiber
13: Optical isolator
14: Second optical fiber
100: Light source device
101: Light source
102: Coupling optical system
103: First optical fiber
104: Optical isolator
105: Second optical fiber
200: Optical transmission system
210: Optical signal transmitter
211: Digital signal processing unit
212: Light source
213, 214: IQ modulator
215: Polarization beam combiner
220: Optical signal receiver
221: Polarization beam splitter
222: Local oscillation light source
223, 224: 90-degree optical hybrid
225-228: Optical-to-electrical converter
229-232: A-D converter
233: Digital signal processing unit
240: Optical transmission path
300: Optical signal transceiver

1. A light source device comprising:
a light source;
a first optical fiber optically connected to the light source;
a second optical fiber for inputting light that has exited from the light source through the first optical fiber and guiding the light incident; and
an optical isolator inserted between the first optical fiber and the second optical fiber,
wherein
the first optical fiber readily generates back-scattering as compared with the second optical fiber.

2. The light source device according to claim 1, wherein the first optical fiber is a polarization maintaining fiber.

3. The light source device according to claim 1,
wherein
the first optical fiber includes a Fiber Bragg Grating, and
Bragg wavelength of the Fiber Bragg Grating differs from the wavelength of the light that has exited from the light source.

4. The light source device according to claim 3, wherein the cycle of the diffraction grating of the Fiber Bragg Grating is a cycle obtained by multiplying a cycle of the diffraction grating assumed when the Bragg wavelength is equal to the wavelength of the light that has exited from the light source by a predetermined coefficient.

5. The light source device according to claim 1, wherein the first optical fiber is a distribution-shifted fiber.

6. The light source device according to claim 1, wherein a core diameter of the first optical fiber is smaller than a core diameter of the second optical fiber.

7. The light source device according to claim 1, further including a coupling optical system between the light source and the first optical fiber.

8. An optical signal transmitter including the light source device according to claim 1.

9. An optical signal receiver including the light source device according to claim 1.

10. An optical signal transceiver including the light source device according to claim 1.

11. An optical transmission system including the optical signal transmitter according to claim 8.

12. A light generating method comprising:
causing light that has exited from a light source to pass through a first optical fiber that readily generates back-scattering as compared with a second optical fiber;
disposing an optical isolator between the first optical fiber and the second optical fiber;
causing the light transmitted through the first optical fiber to pass through the optical isolator; and
inputting the light transmitted through the optical isolator to the second optical fiber.
